(19) United States
(12) Patent Application Publication
(10) Pub. No.: US 2026/0038182 A1
(43) Pub. Date: Feb. 5, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: MASATOSHI ISHII, Tokyo (JP)

(21) Appl. No.: 19/282,965

(22) Filed: Jul. 28, 2025

(30) Foreign Application Priority Data
Jul. 31, 2024 (JP) 2024-124890

(51) Int. Cl. G06T 15/00; G06T 5/50; G06T 7/50

(52) U.S. Cl. CPC G06T 15/00; G06T 5/50; G06T 7/50; G06T 2207/20221

(57) ABSTRACT

An image processing apparatus includes one or more memories storing instructions, and one or more processors executing the instructions to function as, a first generation unit configured to generate a first display image based on image data, and a second generation unit configured to set a shared area having a three-dimensional shape in the first display image and generate a second display image including an image to be shared based on the image data corresponding to the shared area.

### BACKGROUND

### Field of the Technology

The present disclosure relates to image processing for generating an image to be shared.

### Description of the Related Art

As a device enabling a user to experience mixed reality (MR) content, for example, a head mounted display (HMD) is used that is mounted on the head of the user and displays a video image in front of the eyes of the user. With the HMD, generating and displaying an image (e.g., a moving image or a still image) based on, for example, a position and an orientation of the user can provide the user with an experience as if the user were moving in a space where reality and computer graphics (CG) are integrated.

One example of a MR use case is remote operation support, where a third party remotely issues instructions to the user wearing the HMD. In such a case, it is necessary to share an MR image seen through the HMD by the user wearing the HMD with the third party. However, the image to be shared (i.e., the MR image seen through the HMD) may include an area or an object that is not desired to be shared with the third party. To address such a situation, Japanese Patent Application Laid-Open No. 2009-194687 discusses a technique in which privacy-mask processing is performed on a face area and a background area, into which the image to be shared is divided, and those areas are output as different images. This makes it possible to generate an image in which the area not desired to be shared with the third party is subjected to privacy protection.

### SUMMARY

According to an aspect of the present disclosure, an image processing apparatus includes one or more memories storing instructions, and one or more processors executing the instructions to function as, a first generation unit configured to generate a first display image based on image data, and a second generation unit configured to set a shared area having a three-dimensional shape in the first display image and generate a second display image including an image to be shared based on the image data corresponding to the shared area.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of an image display system according to a first exemplary embodiment.

FIG. 2 is a schematic diagram illustrating an example of an internal configuration of a head mounted display (HMD) according to the first exemplary embodiment.

FIG. 3 is a block diagram illustrating an example of a hardware configuration of the image display system according to the first exemplary embodiment.

FIG. 4 is a block diagram illustrating a functional configuration of an image processing apparatus that is a constituent of the image display system according to the first exemplary embodiment.

FIG. 5 is a flowchart illustrating an example of an image processing method using the image display system according to the first exemplary embodiment.

FIG. 6 is a schematic diagram illustrating an example of a mask image according to the first exemplary embodiment.

FIG. 7 is a schematic diagram illustrating an example of a real space and a virtual space seen through the HMD by a user who performs image sharing according to the first exemplary embodiment.

FIG. 8 is a flowchart illustrating details of the display image generation processing in step S501 of FIG. 5.

FIG. 9 is a schematic diagram illustrating an example of a first display image according to the first exemplary embodiment.

FIG. 10 is a schematic diagram illustrating an example of a first depth image corresponding to the first display image of FIG. 9.

FIG. 11 is a flowchart illustrating details of the shared area setting processing in step S502 of FIG. 5.

FIGS. 12A and 12B are schematic diagrams each illustrating the initial shape of a shared area according to the first exemplary embodiment.

FIG. 13 is a schematic diagram illustrating an example of graphical user interfaces (GUIs) for changing a scale and a position of the shape of the shared area according to the first exemplary embodiment.

FIGS. 14A and 14B are schematic diagrams each illustrating an example of a state of the shape of the shared area after the scale and the position are changed by the user according to the first exemplary embodiment.

FIG. 15 is a flowchart illustrating details of the shared area inside-outside determination processing based on a mask in step S505 of FIG. 5.

FIGS. 16A and 16B are schematic diagrams each illustrating an image to be shared that is generated using the mask image of FIG. 6.

FIG. 17 is a flowchart illustrating details of the shared area shape depth image generation processing in step S506 of FIG. 5.

FIGS. 18A and 18B are schematic diagrams each illustrating an example of a generated second depth image according to the first exemplary embodiment.

FIG. 19 is a flowchart illustrating details of the shared area inside-outside determination processing based on a depth in step S507 of FIG. 5.

FIG. 20 is a schematic diagram illustrating an example of an image to be shared that is generated by the shared area inside-outside determination processing based on the depth to which mask processing is applied according to the first exemplary embodiment.

FIG. 21 is a block diagram illustrating a functional configuration of an image processing apparatus that is a constituent of an image display system according to a second exemplary embodiment.

FIG. 22 is a flowchart illustrating an example of an image processing method using the image display system according to the second exemplary embodiment.

FIG. 23 is a schematic diagram illustrating an example of a first display image generated in step S2201 of FIG. 22.

### DESCRIPTION OF THE EMBODIMENTS

### Overall Configuration of Image Processing Apparatus in Exemplary Embodiments

Before disclosing specific exemplary embodiments in detail, the overall configuration of an image processing apparatus in the exemplary embodiments will be described.

The image processing apparatus according to the exemplary embodiments includes a first generation unit configured to generate a first display image, and a second generation unit configured to generate a second display image including an image shared with a part of the first display image. The first display image is an image seen through a first display apparatus, and the second display image is an image seen through a second display apparatus other than the first display apparatus. The second generation unit sets a shared area having a three-dimensional shape in the first display image to generate an image to be shared based on image information included in the shared area. The first display image may include objects not desired to be shared, and it is desirable to acquire the image to be shared excluding the objects. However, in image processing in which the first display image is taken as a two-dimensional image, it is difficult to selectively display only objects desired to be shared. In the exemplary embodiments, the shared area having a three-dimensional shape that allows sharing with a third party is set, and images of only the objects included in the shared area are generated. This makes it possible to exclude the objects not desired to be shared from the first display image to generate the second display image including only the objects desired to be shared. Thus, intended image processing can be performed in consideration of privacy protection.

As a specific example where an image to be shared is generated using image information on only the objects to be shared, the second generation unit generates inside-outside determination images for the inside-outside determination of the shared area in the first display image, and performs the inside-outside determination using the inside-outside determination images to generate an image to be shared. The inside-outside determination images include a mask image and a depth image each corresponding to the shape of the shared area. When a mask image is used for the inside-outside determination, the objects outside the shared area that are subjected to mask processing in the first display image are excluded, and then the image to be shared is generated. When a depth image is used, the objects outside the shared area within a predetermined depth range are excluded, and then the image to be shared is generated. In this case, using a result of the inside-outside determination processing based on the mask in the inside-outside determination processing based on the depth makes it possible to reliably generate a second display image that includes an image to be shared with only the objects desired to be shared in the first display image.

Further, when the user who performs image sharing sees a first display image, the user may wish to check the image to be shared with the third party. To meet such a demand, the image processing apparatus according to the present disclosure further includes a presentation unit configured to present the image to be shared together with the first display image. For example, the presentation unit superimposes and displays the image to be shared on the first display image. This enables the user who performs image sharing to see the image to be shared together with the first display image, improving usability for the user who wishes to check the image to be shared with and seen by the third party.

### Specific Description of Exemplary Embodiments

The exemplary embodiments of the present disclosure will now be described in detail with reference to the drawings. The following exemplary embodiments are not intended to limit the scope of the claims. While a plurality of features is described in the exemplary embodiments, all of the plurality of features are not necessarily essential, and the plurality of features can be optionally combined. Further, in the drawings, like reference numerals refer to like components, and redundant description will be omitted.

A first exemplary embodiment according to the present disclosure will now be described.

### Configuration of Image Display System

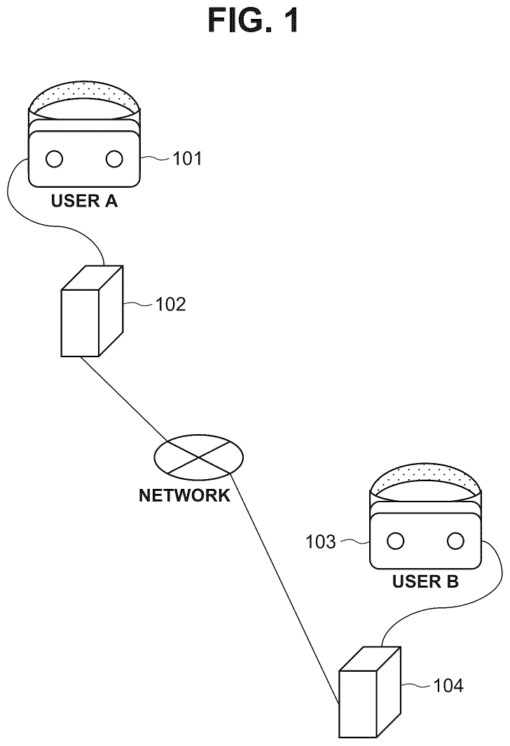

FIG. 1 is a schematic diagram illustrating a configuration of an image display system according to the present exemplary embodiment.

The image display system according to the present exemplary embodiment includes a head mounted display (HMD) 101 serving as an image processing apparatus, and an image processing apparatus 102.

The HMD 101 and the image processing apparatus 102 are electrically connected via a predetermined communication path to transmit and receive various data, such as image data, various kinds of control signals, and the like to and from each other.

In an example illustrated in FIG. 1, the HMD 101 and the image processing apparatus 102 are connected via a cable in compliance with, for example, the high-definition multimedia interface (HDMI®) standards or the universal serial bus (USB) standards. A type of the communication path that connects the HMD 101 and the image processing apparatus 102 is not particularly limited. As a specific example, the communication path between the HMD 101 and the image processing apparatus 102 can be established via wireless communication, such as Bluetooth®. The image processing apparatus 102 used by a user A is connected to an image processing apparatus 104 used by a user B via a network. With the system, when the user A transmits an image being seen by the user A through the HMD 101 to an HMD 103 of the user B, the user B can view through the HMD 103 the image that is being seen by the user A through the HMD 101.

The configuration illustrated in FIG. 1 is merely an example, and the configuration of the image display system according to the present exemplary embodiment is not limited thereto. As a specific example, a not-illustrated input device, such as a controller or a keyboard, to receive inputs from the user A can be connected to the image processing apparatus 102 via a predetermined communication path.

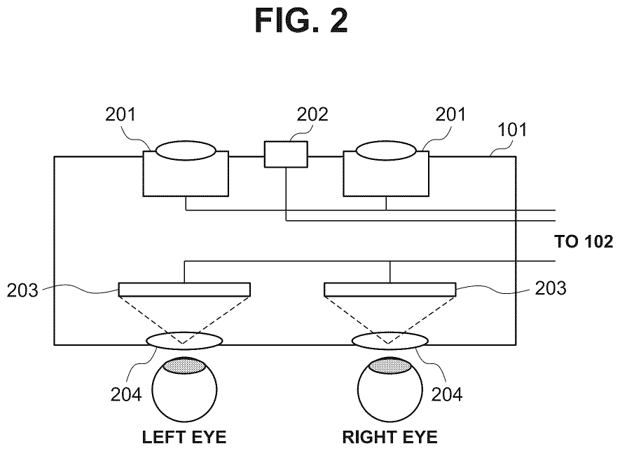

FIG. 2 is a schematic diagram illustrating an example of an internal configuration of the HMD 101.

The HMD 101 includes a plurality of imaging apparatuses 201 (e.g., red-green-blue (RGB) cameras) to visualize a real space. The HMD 101 includes a not-illustrated inertial measurement unit (IMU), such as a gyroscope sensor and an acceleration sensor, an imaging apparatus, and the like in order to perform position tracking.

The HMD 101 includes a component to acquire depth information that indicates a distance to an object positioned in the external environment. For example, in FIG. 2, the HMD 101 includes a distance sensor 202, such as a light detection and ranging (LiDAR) sensor, as the component to acquire depth information.

The HMD 101 includes displays 203 corresponding to the left and right eyes, which are configured to display images using display panels, such as liquid crystal panels or organic electroluminescence (EL) panels. Further, eyepieces 204 are disposed between the displays 203 and the left and right eyes of the user wearing the HMD 101. This configuration enables the user wearing the HMD 101 to see enlarged virtual images of the images displayed on the displays 203 through the eyepieces 204.

The HMD 101 mounted on the head of the user (not illustrated) allows the left eye of the user to see (the enlarged virtual image of) a left-eye display image and the right eye of the user to see (the enlarged virtual image of) a right-eye display image. The image processing apparatus 102 generates the right-eye display image and the left-eye display image to display those images on the respective displays 203 of the HMD 101. In this case, the image processing apparatus 102 may provide parallaxes with the right-eye display image and the left-eye display image based on the interpupillary distance of the user wearing the HMD 101 (e.g., the distance between eyepieces 204 corresponding to the respective eyes). Applying such control makes it possible to provide the user wearing the HMD 101 with a visual perception that includes a sense of depth.

In the present exemplary embodiment, the description focuses on a system configuration in which the image processing apparatus 102 is implemented as an apparatus independent of the HMD 101. However, the configuration of the image display system according to the present exemplary embodiment is not limited thereto. As a specific example, the image display system according to the present exemplary embodiment can be implemented by an integrated HMD system in which a configuration equivalent to the image processing apparatus 102 is incorporated in the HMD 101.

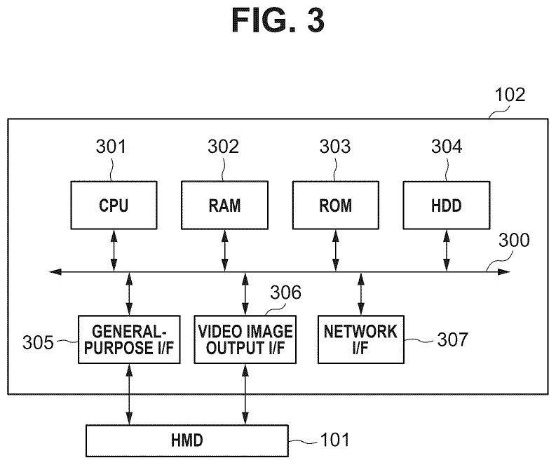

FIG. 3 is a block diagram illustrating an example of a hardware configuration of the image display system according to the present exemplary embodiment.

The image processing apparatus 102 includes a central processing unit (CPU) 301, a random-access memory (RAM) 302, and a read-only memory (ROM) 303. The image processing apparatus 102 further includes a hard disk drive (HDD) 304, a general-purpose interface (I/F) 305, a video image output I/F 306, and a network I/F 307. The above-described series of components of the image processing apparatus 102 are connected to one another to mutually transmit and receive information via a main bus 300.

The CPU 301 is a processor generally controlling the units in the image processing apparatus 102.

The RAM 302 functions as the main memory and a working area, and the like, for the CPU 301. The ROM 303 stores a set of programs to be executed by the CPU 301. The HDD 304 is a storage area that stores applications to be executed by the CPU 301, data to be used in image processing, and the like. The storage area is not limited to the HDD, and various storage devices can be used as the storage area. As a specific example, in place of or in addition to the HDD 304, an auxiliary storage device, such as a solid-state drive (SSD), can be used.

The general-purpose I/F 305 is a serial bus interface in compliance with the USB standards, the Institute of Electrical and Electronics Engineers (IEEE) 1394 standards or the like, and is connected to, for example, the IMU and the distance sensor included in the HMD 101. This enables the image processing apparatus 102 to acquire orientation information, depth images (i.e., a depth image refers to an image in which depth information corresponding to the measured distance to a target object for each pixel is mapped), and the like from the HMD 101. The general-purpose I/F 305 is also used to acquire images based on imaging results from the imaging apparatuses 201 of the HMD 101.

The video image output I/F 306 is an interface, such as an HDMI® or a display port, and is used to transmit to the HMD 101 the display images to be displayed on the displays 203 of the HMD 101.

The network I/F 307 is an interface to connect the image processing apparatus 102 to a predetermined network. The configuration of the network I/F 307 can be appropriately changed based on a type of the network to be connected or an applied communication method.

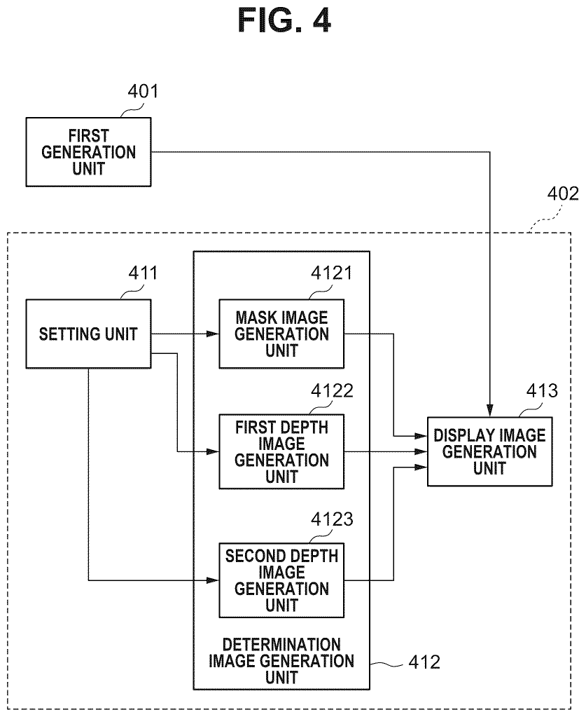

FIG. 4 is a block diagram illustrating a functional configuration of the image processing apparatus 102 that is a constituent of the image display system. The image display system will be described with particular focus on the configuration of the image processing apparatus 102 with reference to FIG. 4.

The image processing apparatus 102 includes a first generation unit 401 and a second generation unit 402.

The second generation unit 402 includes a setting unit 411, a determination image generation unit 412, and a display image generation unit 413.

The determination image generation unit 412 includes a mask image generation unit 4121, a first depth image generation unit 4122, and a second depth image generation unit 4123.

The first generation unit 401 generates a first display image to be seen, for example, through the HMD 101, by the user who performs image sharing. The first display image is generated by, for example, compositing a captured image and a computer graphics (CG) image.

The second generation unit 402 generates a second display image including an image shared with a part of the first display image. The second display image is an image seen, for example, through the HMD 103 by a user (a third party) who receives image sharing, as illustrated in FIG. 1. The second display image is provided from the image processing apparatus 102 to the image processing apparatus 104.

The setting unit 411 sets a shared area that the user who performs image sharing wishes to share, as three-dimensional shape information.

The determination image generation unit 412 generates images necessary to perform inside-outside determination processing on the shared area with respect to the first display image.

The second generation unit 402 performs the inside-outside determination processing on the shared area with respect to the first display image to generate an image to be shared.

The mask image generation unit 4121 projects the three-dimensional shape indicating the shared area onto a two-dimensional plane using the same path as that of CG rendering in the display image generation to generate a mask image to be used in the inside-outside determination processing.

The first depth image generation unit 4122 generates a first depth image indicating depth information from the viewpoint position with respect to the first display image.

The second depth image generation unit 4123 generates a second depth image indicating depth information with respect to the three-dimensional shape indicating the shared area.

### Main Procedure

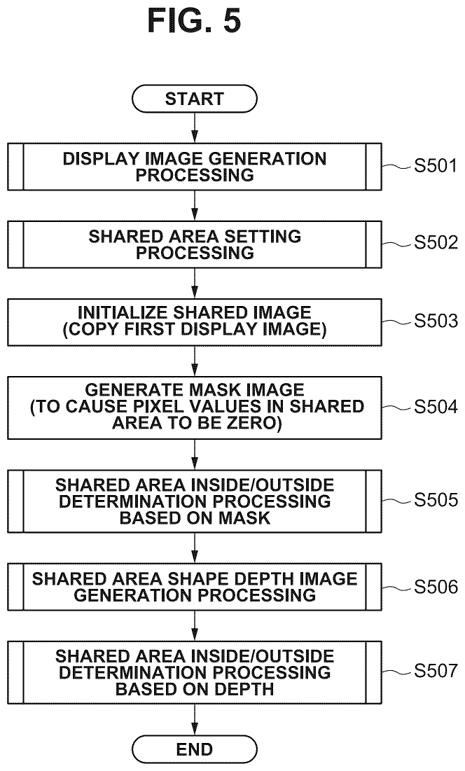

FIG. 5 is a flowchart illustrating an example of an image processing method using the image display system according to the present exemplary embodiment. An example of processing by the image display system according to the present exemplary embodiment will be described with particular focus on processing performed by the image processing apparatus 102 with reference to FIG. 5.

A series of processing illustrated in FIG. 5 is performed by programs stored in the ROM 303 or in the HDD 304 being loaded to the RAM 302, and the CPU 301 executing the loaded programs in the image processing apparatus 102. In this manner, the CPU 301 functions as the components illustrated in FIG. 4.

In step S501, the first generation unit 401 composites a captured image and a CG image to generate the first display image seen through the HMD 101 by the user who performs image sharing. During the processing in step S501, the first depth image generation unit 4122 generates the first depth image that indicates the depth information from the viewpoint position with respect to a captured object and a CG object included in the first display image. Details of the processing will be described below.

In step S502, the setting unit 411 sets a shared area indicating the area that the user who performs image sharing wishes to share, as three-dimensional shape information. Details of the processing will be described below. As a method of setting a shared area, the setting unit 411 can read information indicating a shared area previously generated and stored.

In step S503, the display image generation unit 413 performs initialization processing. In this case, the display image generation unit 413 copies the first display image generated in step S501 to initialize the image to be shared. Thus, the first display image and the image to be shared are equal in size and pixel values at this point in time.

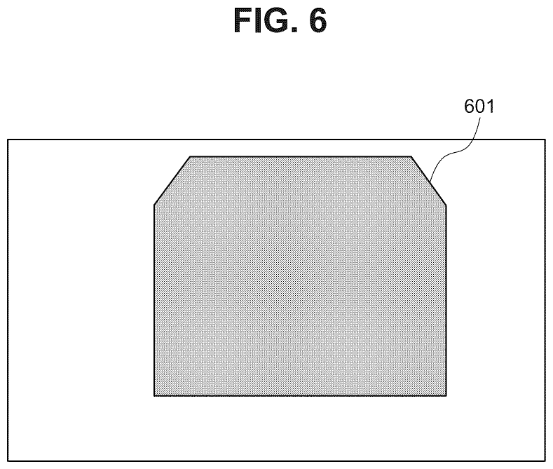

In step S504, the mask image generation unit 4121 projects the three-dimensional shape indicating the shared area onto the two-dimensional plane using the same path as that of the CG rendering in the display image generation processing in step S501 to generate a mask image to be used in the inside-outside determination processing. The mask image is generated with the same size and the same resolution as those of the first display image. FIG. 6 illustrates an example of the mask image. In this case, the mask image is generated such that pixel values in an area 601 corresponding to the shared area in the mask image are zero, and pixel values outside the area 601 are other than zero.

In step S505, the display image generation unit 413 applies the mask image generated in step S504 to the first display image to perform the inside-outside determination processing on the shared area. Details of the processing will be described below.

In step S506, the second depth image generation unit 4123 generates the second depth image that indicates depth information with respect to the three-dimensional shape indicating the shared area. Details of the processing will be described below.

In step S507, the display image generation unit 413 performs the inside-outside determination processing on the shared area based on the first depth image indicating depth information with respect to the first display image generated during the processing in step S501 and the second depth image that indicates depth information with respect to the three-dimensional shape indicating the shared area generated in step S506. Details of the processing will be described below.

### Display Image Generation Processing

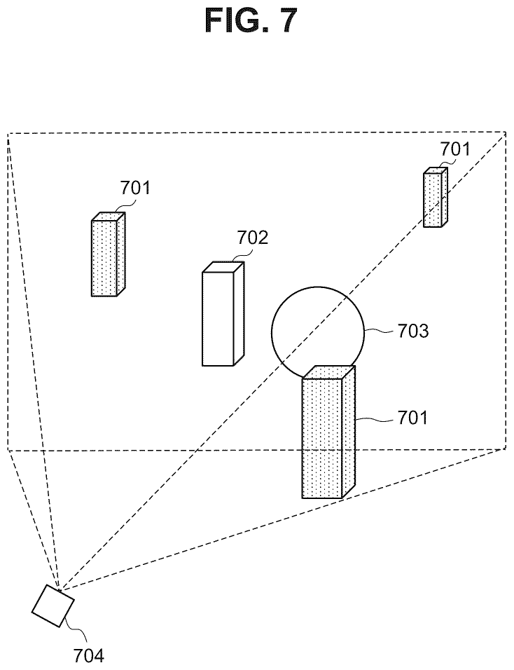

FIG. 7 is a schematic diagram illustrating an example of a real space and a virtual space seen through the HMD 101 by the user who performs image sharing according to the present exemplary embodiment.

In the real space, real objects 701 that are not desired to be shared and a real object 702 that is desired to be shared exist. In the virtual space, a CG object 703 desired to be shared exists. Further, a position 704 indicates a position of the user in the real space or in the virtual space. In the real space, the HMD 101 is at the position 704, whereas in the virtual space, a virtual camera is at the position 704.

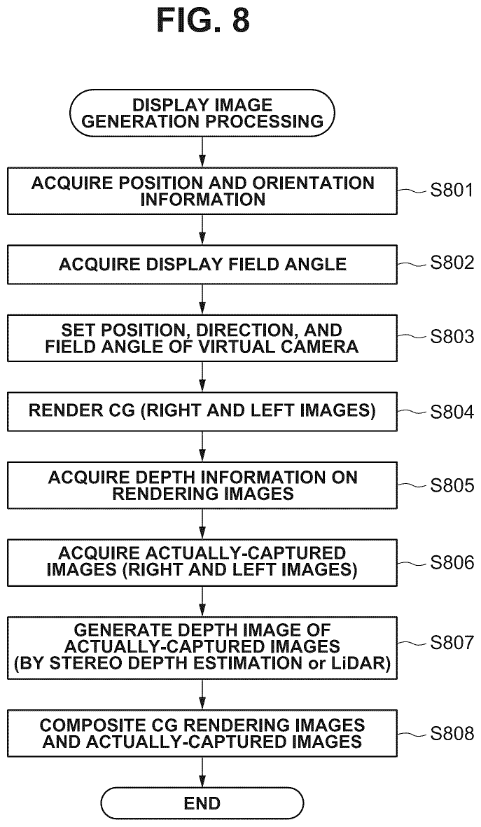

Details of the display image generation processing in step S501 of FIG. 5 will be described with reference to FIG. 8.

In step S801, the first generation unit 401 acquires information on the position and orientation of the HMD 101 by using information acquired from the IMU and a well-known self-position estimation technique, such as simultaneous localization and mapping (SLAM).

In step S802, the first generation unit 401 acquires a display field angle of the HMD 101 from device information.

In step S803, the first generation unit 401 sets a position, a direction, and a field angle of the virtual camera used for CG rendering. The position and the orientation of the virtual camera are set to match the position and the orientation of the HMD 101 acquired in step S801. In this case, both the position of the HMD 101 in the real space acquired in step S801 and the position of the virtual camera in the virtual space are represented using the same world coordinate system. The field angle of the virtual camera is set to match the display field angle of the HMD 101 acquired in step S802.

In step S804, using the virtual camera set in step S803, the first generation unit 401 processes the CG to be superimposed on the real space using a well-known CG rendering method, such as a rasterizing method, to generate rendering images. Two images corresponding to the right eye and the left eye are generated as the rendering images. To three-dimensionally perceive the CG, it is necessary to present images having parallax to the right eye and the left eye, respectively. Thus, the position of the virtual camera set in step S803 is shifted by a distance equivalent to the distance between both the eyes, and the rendering processing corresponding to each of the right eye and the left eye is performed to generate left and right rendering images.

In step S805, the first generation unit 401 generates depth images corresponding to the rendering images based on the distance information related to each of the CG objects acquired in the process of the rendering processing in step S804.

In step S806, the first generation unit 401 acquires two captured images corresponding to the left and right eyes from the imaging apparatuses 201 included in the HMD 101. The captured images are corrected in aberration, such as lens distortion of the imaging apparatuses 201, and then subjected to processing, such as cropping, to match the field angle of the captured images with the display field angle acquired in step S802.

In step S807, the first generation unit 401 generates depth images corresponding to the captured images.

The depth images can be generated by performing well-known stereo depth estimation processing on the captured images acquired by the imaging apparatuses 201, or they can be generated based on distance information acquired from the distance sensor 202, such as LiDAR.

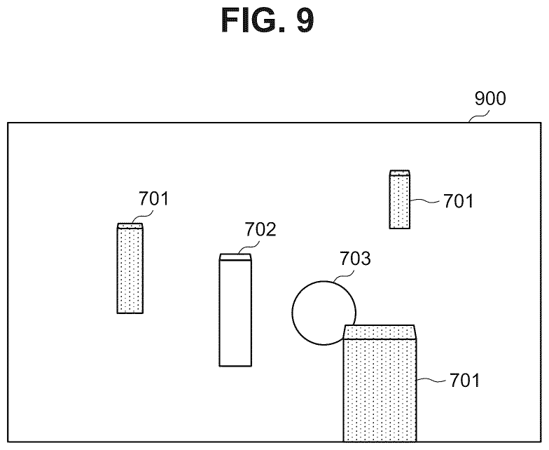

In step S808, the first generation unit 401 performs compositing processing on the rendering images generated in step S804 and the captured images acquired in step S806 to generate the first display image. In the compositing processing, the depth images corresponding to the rendering images generated in step S805 and the depth images corresponding to the captured images generated in step S807 are used to perform processing with occlusion taken into consideration. FIG. 9 illustrates an example of the first display image. The real objects 701 not desired to be shared, the real object 702 desired to be shared, and the CG object 703 desired to be shared are all included in a first display image 900.

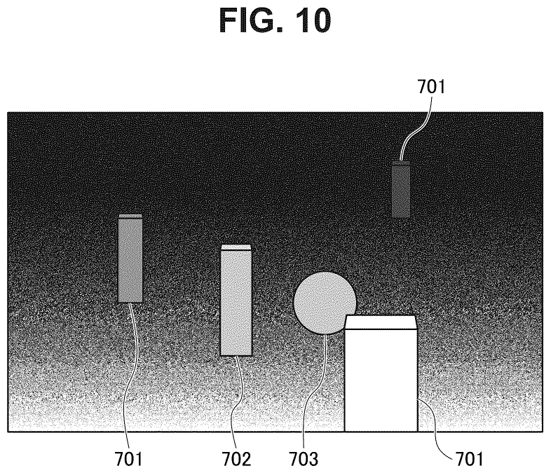

Further, compositing processing is performed on the depth images corresponding to the rendering images and the depth images corresponding to the captured images to generate a first depth image corresponding to the first display image. FIG. 10 illustrates an example of the first depth image corresponding to the first display image of FIG. 9. The first depth image is one-channel image data having, for example, eight-bit gradation. In this case, as the brightness of a pixel value in the image decreases (i.e., as a pixel value is smaller), the distance increases.

### Setting Processing on Shared Area

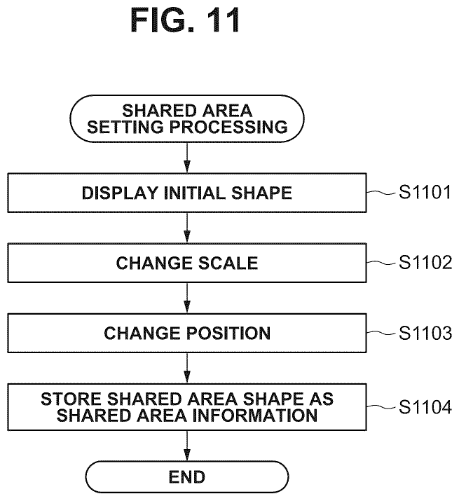

FIG. 11 is a flowchart illustrating details of the shared area setting processing in step S502 for FIG. 5.

In step S1101, the setting unit 411 displays the initial shape of the shared area, which is a three-dimensional shape indicating the shared area, at a predetermined position, for example, at the center of a screen.

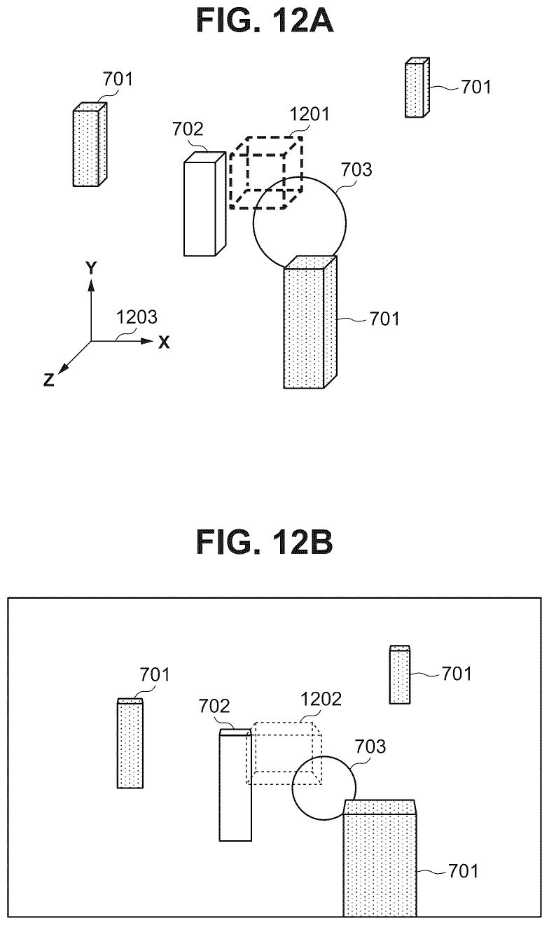

FIGS. 12A and 12B are schematic diagrams each illustrating the initial shape of the shared area according to the present exemplary embodiment.

FIG. 12A illustrates an example of a relationship between the real objects and the CG object and a shared area shape 1201 in the three-dimensional space. FIG. 12A illustrates an example where a wire frame indicating the shape of the shared area is illustrated. A coordinate system 1203 is the same coordinate system as that used in the display image generation processing. The shared area shape 1201 is set as a CG object in the virtual space. The setting unit 411 performs rendering processing on the shared area shape 1201 by using a rendering path similar to that used in the display image generation processing, and composites the shared area shape 1201 with the first display image to display the shape of the shared area on the displays 203 of the HMD 101. FIG. 12B illustrates a shared area shape 1202 composited on the first display image.

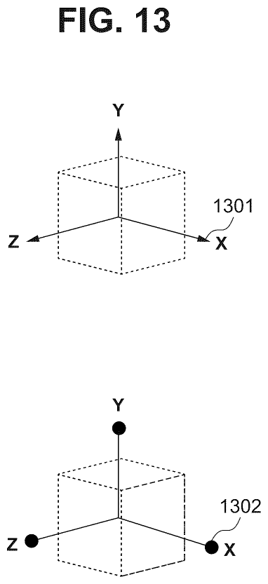

In steps S1102 and S1103, the setting unit 411 changes a size (a scale) and a position of the shape of the shared area initially set in step S1101. FIG. 13 is a schematic diagram illustrating an example of graphical user interfaces (GUIs) for changing the scale and the position of the shape of the shared area. The user operates a position adjustment user interface (UI) 1301 and a scale adjustment UI 1302 via an input device, such as a controller, to change the scale and the position of the shape of the shared area. As for the position, the user selects each of the three axes (i.e., X, Y, and Z axes) of the position adjustment UI 1301 using the controller and performs extension or contraction in the direction of each axis to move the shape of the shared area along each axis. As for the scale, the user selects each of the X, Y, and Z axes of the scale adjustment UI 1302 using the controller and performs extension or contraction in the direction of each axis to change the scale of the shape of the shared area along each axis.

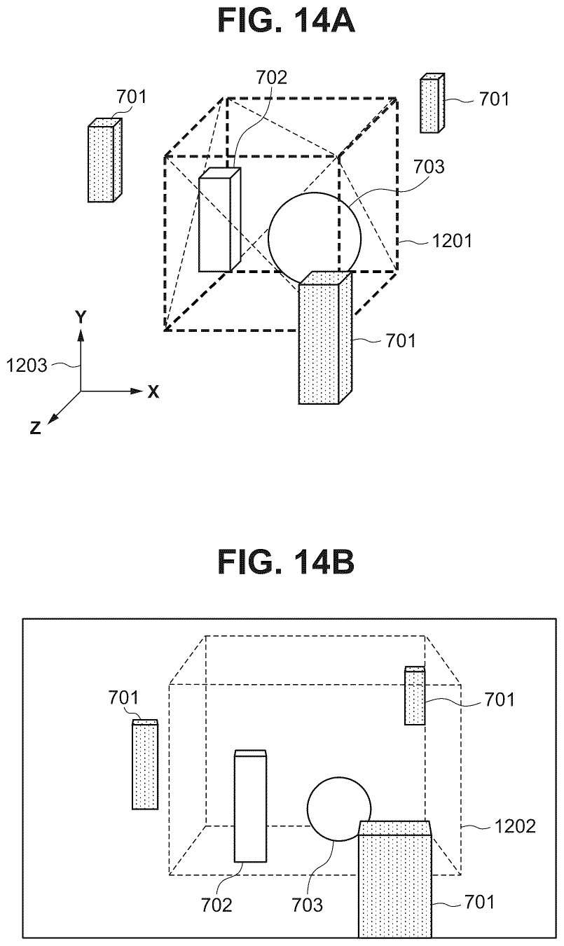

FIGS. 14A and 14B are schematic diagrams each illustrating an example of a state of the shared area shape 1201 after the scale and the position are changed by the user. FIG. 14A illustrates an example of a relationship between the real objects and the CG object and the shared area shape 1201 changed in scale and position in the three-dimensional space. FIG. 14B illustrates the shared area shape 1202 changed in scale and position and composited on the first display image. As illustrated, a primitive shape that is a three-dimensional shape indicating the shared area is set such that a real object and the CG object, both of which are desired to be shared, are included in the shared area. As described above, in the present exemplary embodiment, the user who performs image sharing can easily set the shared area having the three-dimensional shape to a desired position and a desired size in the first display image.

In step S1104, the setting unit 411 stores in the RAM 302 the three-dimensional shape information related to the shape of the shared area that is adjusted and changed by the user in steps S1102 and S1103 as shared area information.

In the present exemplary embodiment, a rectangular parallelepiped is used as the shape of the shared area. However, the shape is not limited thereto. For example, a spherical shape or other three-dimensional shapes can be used as the shape of the shared area. Further, the method of changing a position and a scale of the shape of the shared area is not limited to the above-described method. For example, coordinates of each vertex of the shape of the shared area can be individually changed.

### Inside-Outside Determination Processing on Shared Area Based on Mask

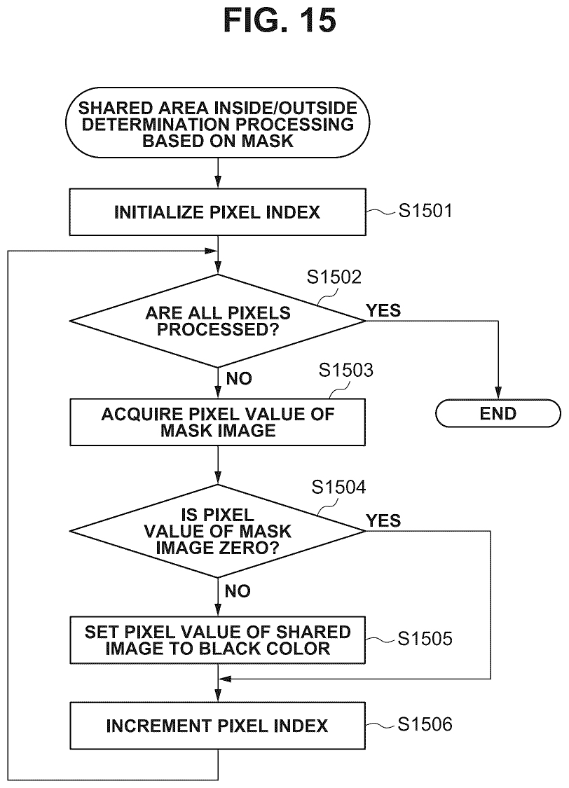

FIG. 15 is a flowchart illustrating details of the shared area inside-outside determination processing based on the mask in step S505 of FIG. 5.

In step S1501, the display image generation unit 413 initializes the pixel index for the mask image and the image to be shared.

In step S1502, the display image generation unit 413 determines whether all pixels of the image to be shared have been processed. If all pixels of the image to be shared have been processed (YES in step S1502), the shared area inside-outside determination processing based on the mask ends. If all pixels of the image to be shared have not been processed (NO in step S1502), the processing proceeds to step S1503.

In step S1503, the display image generation unit 413 acquires a pixel value of the mask image (generated in step S504) pixel corresponding to the currently set pixel index.

In step S1504, the display image generation unit 413 determines whether the pixel value of the mask image pixel acquired in step S1503 is equal to zero. If the pixel value of the mask image pixel is equal to zero (YES in step S1504), the processing proceeds to step S1506. If the pixel value of the mask image pixel is not equal to zero (NO in step S1504), the processing proceeds to step S1505.

In step S1505, the display image generation unit 413 replaces the pixel value of the pixel of the image to be shared corresponding to the currently set pixel index with (R, G, B)=(0, 0, 0), which represents black.

In step S1506, the display image generation unit 413 increments the value of the pixel index to indicate the next unprocessed pixel, if any. The processing then returns to step S1502.

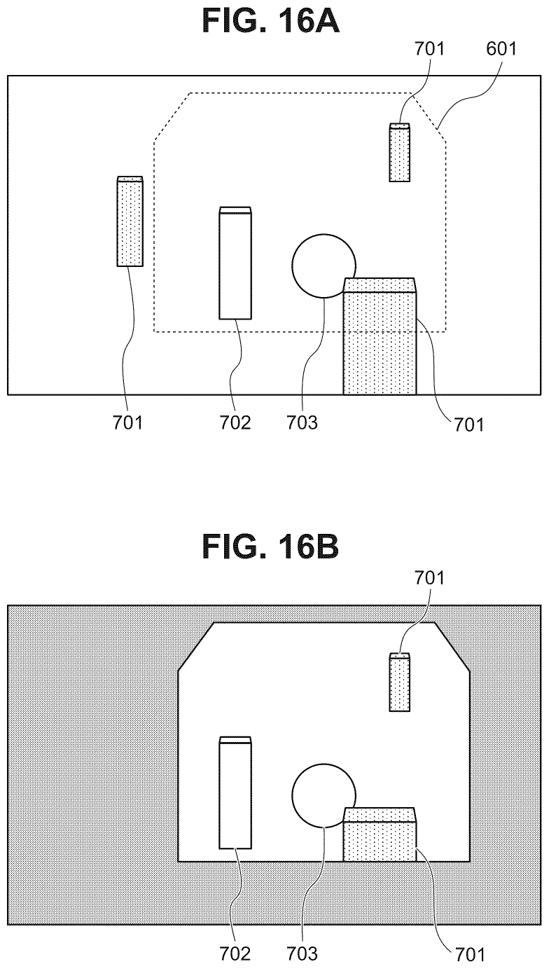

FIGS. 16A and 16B are schematic diagrams each illustrating the image to be shared that is generated using the mask image of FIG. 6.

FIG. 16A illustrates a relationship between the first display image and the area 601 corresponding to the shared area in the mask image. It can be understood that, by performing mask processing on the first display image to generate the image to be shared, some of the real objects 701 not desired to be shared are excluded. The mask processing produces the effect of excluding objects spatially positioned above, below, on the left, and on the right of the shared area. FIG. 16B illustrates an example of the image to be shared that is generated in such a manner. In this case, it can be understood that the pixels in the area not desired to be shared are colored in black.

### Depth Image Generation Processing for Shape of Shared Area

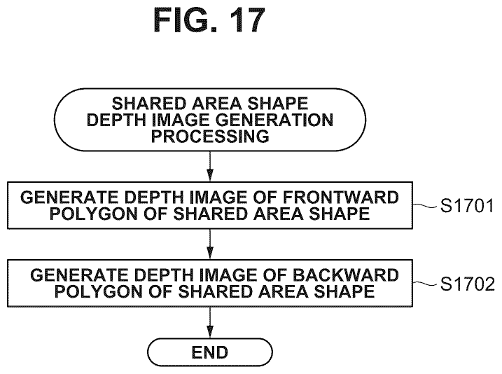

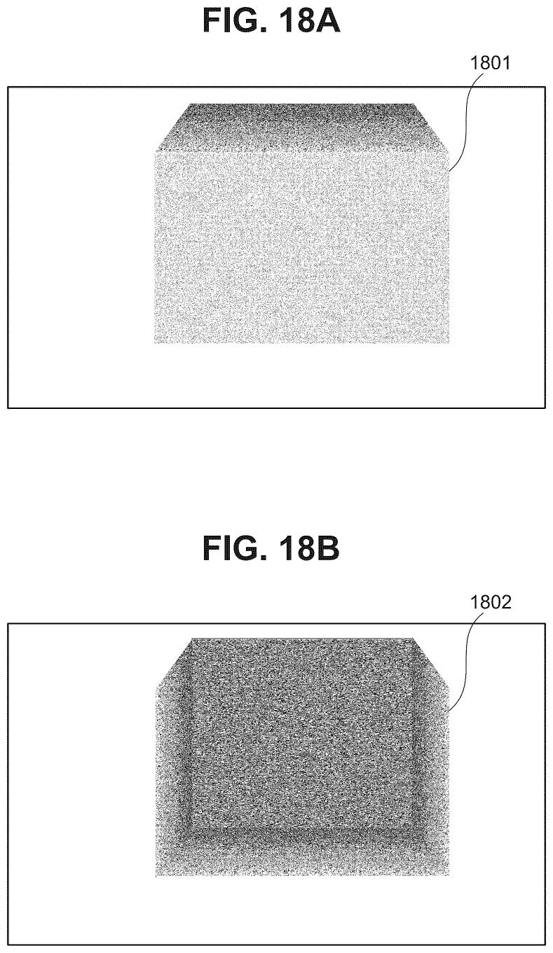

FIG. 17 is a flowchart illustrating details of the shared area shape depth image generation processing in step S506 of FIG. 5. FIGS. 18A and 18B are schematic diagrams each illustrating an example of the generated second depth image. In the present exemplary embodiment, the second depth image includes a front depth image and a back depth image.

In step S1701, the second depth image generation unit 4123 generates the front depth image of the shape of the shared area. Specifically, among the polygons that constitute the shared area, only the front-facing polygons of the shape of the shared area are rendered, using a rendering path similar to that used in the display image generation processing, to generate the front depth image of the polygon surfaces that face the virtual camera.

FIG. 18A illustrates an example of a front depth image 1801 corresponding to the front-facing polygons of the shape of the shared area. The front depth image 1801 is one-channel image data having, for example, eight-bit gradation. In this case, as the brightness of a pixel value in the image decreases (i.e., as a pixel value is smaller), the distance increases.

In step S1702, the second depth image generation unit 4123 generates the back depth image of the shape of the shared area. Specifically, among the polygons that constitute the shared area, only the back-facing polygons of the shape of the shared area are rendered, using a rendering path similar to that used in the display image generation processing, to generate the back depth image of the polygon surfaces, the back sides of these polygon surfaces facing the virtual camera. In this case, processing is performed on the back-facing polygons, and thus, back-face culling is not performed.

FIG. 18B illustrates an example of a back depth image 1802 corresponding to the back-facing polygons of the shape of the shared area. As in FIG. 18A, the back depth image 1802 is one-channel image data having, for example, eight-bit gradation. In this case, as the brightness of a pixel value in the image decreases (i.e., as a pixel value is smaller), the distance increases.

### Inside-Outside Determination Processing on Shared Area Based on Depth

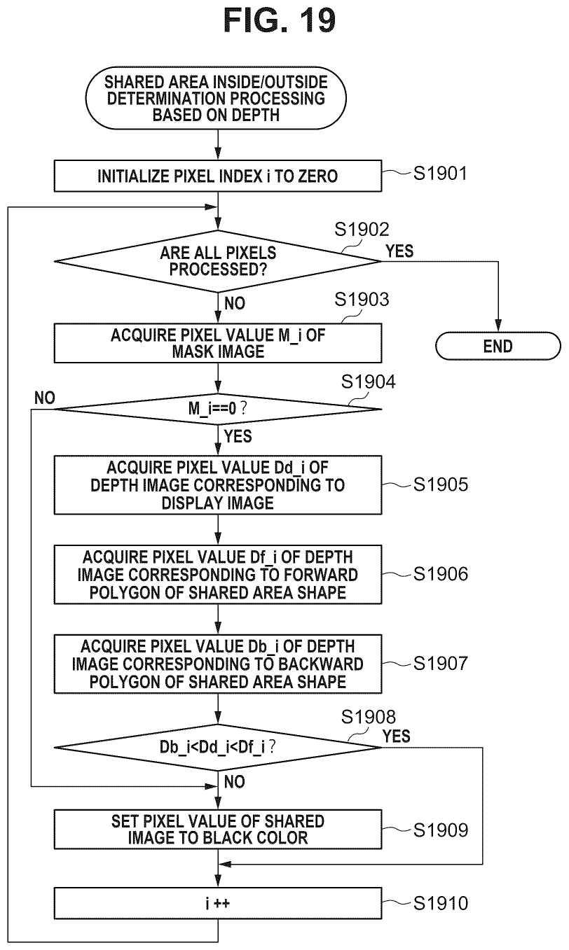

FIG. 19 is a flowchart illustrating details of the shared area inside-outside determination processing based on the depth in step S507 of FIG. 5. A case where a result of the depth image generation processing for the shape of the shared area is applied to the shared area inside-outside determination processing based on the depth will be described.

In step S1901, the display image generation unit 413 initializes a pixel index i for the depth image and the image to be shared to a value of zero.

In step S1902, the display image generation unit 413 determines whether all pixels of the image to be shared have been processed. If all pixels of the image to be shared have been processed (YES in step S1902), the shared area inside-outside determination processing based on the depth ends. If all pixels of the image to be shared have not been processed (NO in step S1902), the processing proceeds to step S1903.

In step S1903, the display image generation unit 413 acquires a pixel value M_i of a pixel of the mask image acquired in step S1503.

In step S1904, the display image generation unit 413 determines whether the pixel value M_i of the mask image acquired in step S1903 is equal to zero. If the pixel value M_i of the mask image is equal to zero (YES in step S1904), the processing proceeds to step S1905. If the pixel value M_i of the mask image is not equal to zero (NO in step S1904), the processing proceeds to step S1909.

In step S1905, the display image generation unit 413 acquires a pixel value Dd_i of a pixel of the first depth image (FIG. 10) corresponding to the first display image generated in step S808.

In step S1906, the display image generation unit 413 acquires a pixel value Df_i of a pixel of the second depth image corresponding to the front-facing polygons of the shape of the shared area that is generated in step S1701.

In step S1907, the display image generation unit 413 acquires a pixel value Db_i of a pixel of the second depth image corresponding to the back-facing polygons of the shape of the shared area that is generated in step S1702.

In step S1908, the display image generation unit 413 determines whether the pixel of the image to be shared corresponding to the currently set pixel index corresponds to an object that is inside or outside the shared area. Specifically, if Dd_i<Df_i and Dd_i>Db_i are satisfied (i.e., when Db_i<Dd_i<Df_i is satisfied) (YES in step S1908), it is determined that the pixel corresponds to an object inside the shared area, and the processing proceeds to step S1910. If the above-described conditional inequalities are not satisfied (NO in step S1908), it is determined that the object is outside the shared area, and the processing proceeds to step S1909.

In step S1909, the display image generation unit 413 replaces the pixel value of the pixel of the image to be shared corresponding to the currently set pixel index with (R, G, B)=(0, 0, 0), which represents black.

In step S1910, the display image generation unit 413 increments the pixel index i.

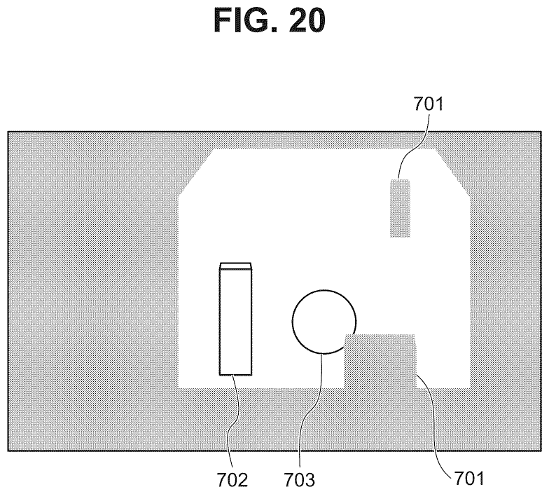

FIG. 20 is a schematic diagram illustrating an example of the image to be shared that is generated by the shared area inside-outside determination processing based on the depth to which the mask processing is applied.

By comparing the image to be shared illustrated in FIG. 20 with the image to be shared after the mask processing illustrated in FIG. 16B, it can be understood that the objects determined to be three-dimensionally positioned outside the shape of the shared area based on their depths have further changed to black. The depth processing produces the effect of excluding from the image to be shared objects not desired to be shared present in a particular depth direction.

As described above, according to the present exemplary embodiment, an image display system is implemented that includes an image processing apparatus 102 that can generate an image to be shared, which includes only the objects allowed to be shared with a third party, and can perform image processing with privacy protection taken into consideration.

In the present exemplary embodiment, the example is described where a pixel value in the area that is not included in the shape of the shared area is colored black. However, the fill color can be a color other than black. Further, in place of filling processing, well-known blurring processing using, for example, a Gaussian filter can be used to make it impossible to identify the objects not desired to be shared.

The method of setting the shared area is not limited to the method of deforming the initial shape described in the present exemplary embodiment, and other methods can be used. For example, a method can be used of causing the user to set both shape information on an area corresponding to the bottom surface of the shared area and height information on the shared area and then determine a three-dimensional shape of the shared area to be set. Another method can be used of automatically setting a three-dimensional shape so as to include all specific objects designated by the user.

Furthermore, it is unnecessary to generate information on the shared area every time, and information on the shared area previously set and stored can be read and used.

In the present exemplary embodiment, the example of mixed reality (MR) that composites and displays a captured image and a CG image is described. However, the effect can be produced in virtual reality (VR) using only CG images by performing similar processing. In the display image generation processing illustrated in the flowchart of FIG. 8, the processing for the captured images is skipped, and the CG rendering images are used as the first display image without performing compositing with the captured images in step S808. In this case, a world coordinate system set in the virtual space is used.

A second exemplary embodiment according to the present disclosure will now be described. In the second exemplary embodiment, a configuration will be described that causes the user who performs image sharing to recognize an image to be shared that is generated by the method described in the first exemplary embodiment.

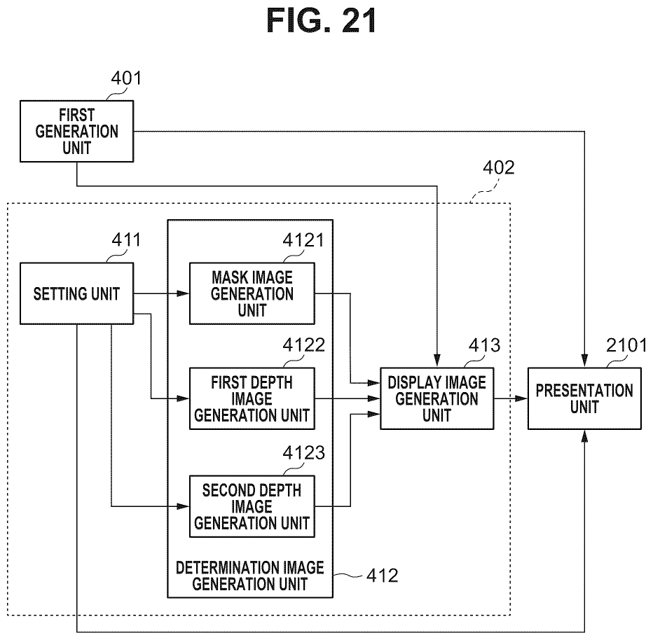

FIG. 21 is a block diagram illustrating a functional configuration of the image processing apparatus 102 that is a constituent of an image display system according to the present exemplary embodiment. The image display system will be described with particular focus on the configuration of the image processing apparatus 102 with reference to FIG. 21. The functional configuration of the image display system according to the present exemplary embodiment is the functional configuration according to the first exemplary embodiment illustrated in FIG. 4 with the addition of a presentation unit 2101. Thus, like reference numerals refer to like components common to the functional configuration according to the first exemplary embodiment, and the redundant description will be omitted.

The presentation unit 2101 superimposes an image to be shared that is generated by the second generation unit 402 on the first display image generated by the first generation unit 401. Alternatively, the presentation unit 2101 superimposes a shared area set by the setting unit 411 on the first display image. This allows the user who performs image sharing to recognize an image actually being shared with a third party.

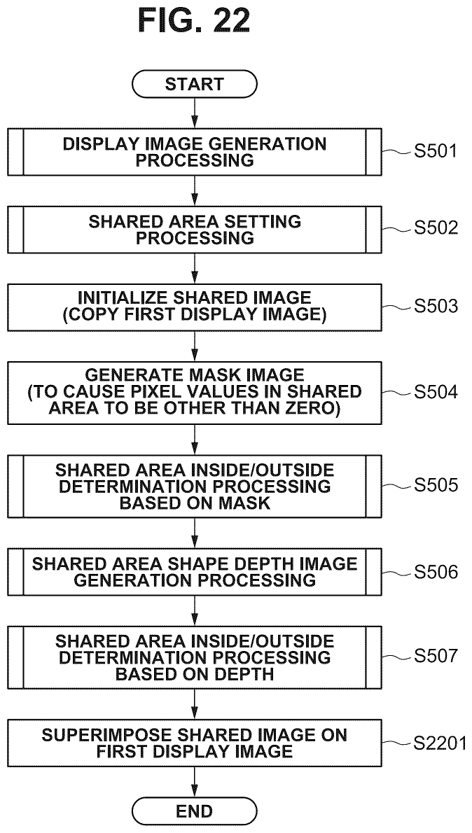

FIG. 22 is a flowchart illustrating an example of an image processing method using the image display system according to the present exemplary embodiment. An example of the processing by the image display system according to the present exemplary embodiment will be described with reference to FIG. 22 with particular focus on processing performed by the image processing apparatus 102.

A series of processing illustrated in FIG. 22 is performed by programs stored in the ROM 303 or the HDD 304 being loaded to the RAM 302, and the CPU 301 executing the loaded programs in the image processing apparatus 102. As a result, the CPU 301 functions as the components illustrated in FIG. 21. Steps common to the main procedure according to the first exemplary embodiment are denoted by the same reference numerals in FIG. 5, and the description of such steps will be omitted. Step S2201, which is not included in the first exemplary embodiment, will be described.

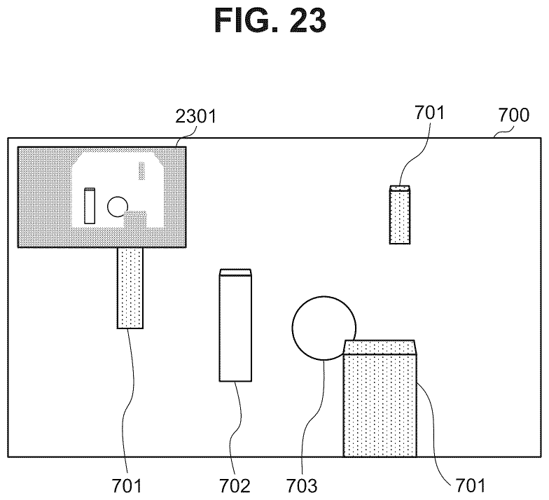

In step S2201, the presentation unit 2101 superimposes the image to be shared that is generated in step S507 on the first display image generated in step S501 to update the first display image. For example, the presentation unit 2101 resizes the image to be shared, and composites and superimposes the resized image to be shared on a partial area of the first display image in a picture-in-picture format. FIG. 23 is a schematic diagram illustrating an example of the first display image generated in step S2201 of FIG. 22. FIG. 23 illustrates a state where a shared image 2301 is superimposed on the upper left area of a first display image 700 in a picture-in-picture format.

The above-described processing allows the user to recognize the image being shared with a third party, improving usability for the user who performs image sharing and wishes to check the image being shared with and being viewed by the third party.

In the present exemplary embodiment, the processing for allowing the user who performs image sharing to recognize the image being shared is described. However, a mode for switching the processing on and off can be provided, and control for switching whether to superimpose the image to be shared on the first display image can be performed based on the on or off state.

In the present exemplary embodiment, the processing of superimposing the image to be shared itself on the first display image is described. However, a similar effect can be produced by superimposing the shape of the shared area on the first display image. This can be realized by displaying the wire frame of the shape of the shared area on the first display image using a procedure similar to the setting processing on the shared area as illustrated in FIG. 14B.

### Other Exemplary Embodiments

The exemplary embodiments of the present disclosure have been described in detail above. The present disclosure can be implemented as, for example, a system, an apparatus, a method, a program, or a recording medium (a storage medium). Specifically, the present disclosure may be applied to a system including a plurality of apparatuses (e.g., a host computer, an interface apparatus, an imaging apparatus, and a web application), or may be applied to a single apparatus. Programs for carrying out the functions of the components illustrated in FIG. 4 and FIG. 21, and programs for causing a computer to execute the steps illustrated in FIGS. 5, 8, 11, 15, 17, 19, and 22 described above are included in the present disclosure.

The purpose of the present disclosure can be achieved as follows. A recording medium (or a storage medium) that records a program code (a computer program) of software for carrying out the functions of the above-described exemplary embodiments is supplied to a system or an apparatus. The storage medium is, needless to say, a computer-readable storage medium. Further, a computer (or a CPU or a microprocessor unit (MPU)) of the system or the apparatus reads and executes the program code stored in the recording medium. In this case, the program code itself read from the recording medium carries out the functions of the above-described exemplary embodiments, and the computer-readable recording medium that records the program code is included in the present disclosure.

According to the exemplary embodiments of the present disclosure, an image to be shared including only an object desired to be shared with a third party can be generated. As a result, an image processing apparatus is implemented that can perform image processing with privacy protection taken into consideration.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-124890, filed Jul. 31, 2024, the entirety of which is incorporated herein by reference.

What is claimed is:

1. An image processing apparatus comprising:
one or more memories storing instructions; and
one or more processors executing the instructions to function as:
a first generation unit configured to generate a first display image based on image data; and
a second generation unit configured to set a shared area having a three-dimensional shape in the first display image and generate a second display image including an image to be shared based on the image data corresponding to the shared area.

2. The image processing apparatus according to claim 1,
wherein the first display image is an image seen through a first display apparatus, and
wherein the second display image is an image seen through a second display apparatus different from the first display apparatus.

3. The image processing apparatus according to claim 1, wherein the second generation unit includes a setting unit configured to set the shared area.

4. The image processing apparatus according to claim 3, wherein the setting unit sets an initial shape of the shared area in the first display image and changes a position and a size of the initial shape to set the shared area.

5. The image processing apparatus according to claim 3, wherein the second generation unit includes a determination image generation unit configured to generate an inside-outside determination image for performing inside-outside determination on the shared area in the first display image.

6. The image processing apparatus according to claim 5, wherein the second generation unit includes a display image generation unit configured to perform the inside-outside determination by using the inside-outside determination image to generate the image to be shared.

7. The image processing apparatus according to claim 6,
wherein the determination image generation unit includes a mask image generation unit configured to generate a mask image by projecting the three-dimensional shape of the shared area onto a two-dimensional plane, and
wherein the display image generation unit performs the inside-outside determination by using the mask image to generate the image to be shared.

8. The image processing apparatus according to claim 6,
wherein the determination image generation unit includes a first depth image generation unit configured to generate a first depth image indicating depth information with respect to the first display image from a viewpoint position, and a second depth image generation unit configured to generate a second depth image indicating depth information with respect to the shared area from the viewpoint position, and
wherein the display image generation unit performs the inside-outside determination to generate the image to be shared by comparing the first depth image and the second depth image.

9. The image processing apparatus according to claim 8, wherein the second depth image generation unit generates, as the second depth image, an image in which only front-facing polygons constituting the three-dimensional shape of the shared area are rendered and an image in which only back-facing polygons constituting the three-dimensional shape of the shared area are rendered.

10. The image processing apparatus according to claim 1, wherein the one or more processors executing the instructions further function as: a presentation unit configured to present the image to be shared together with the first display image.

11. The image processing apparatus according to claim 10, wherein the presentation unit superimposes and displays the image to be shared on the first display image.

12. An image processing method comprising the steps of:
generating a first display image based on image data;
setting a shared area having a three-dimensional shape in the first display image; and
generating a second display image including an image to be shared based on the image data corresponding to the shared area.

13. A non-transitory computer-readable storage medium storing instructions that, when executed by a computer, cause the computer to perform a method comprising the steps of:
generating a first display image based on image data
setting a shared area having a three-dimensional shape in the first display image; and
generating a second display image including an image to be shared based on the image data corresponding to the shared area.
